(19) United States
(12) Patent Application Publication
(10) Pub. No.: US 2013/0118872 A1
(43) Pub. Date: May 16, 2013

(54) SWITCH LATCH FOR AN ELECTRICAL SWITCHING DEVICE

(71) Applicants: Gregor Fleitmann, Kerpen (DE); Volker Heins, Rheinbach (DE); Detlef Koch, Koeln (DE); Bogdan Zabrocki, Neunkirchen-Seelscheid (DE)

(72) Inventors: Gregor Fleitmann, Kerpen (DE); Volker Heins, Rheinbach (DE); Detlef Koch, Koeln (DE); Bogdan Zabrocki, Neunkirchen-Seelscheid (DE)

(73) Assignee: EATON ELECTRICAL IP GMBH & CO. KG, Schoenefeld (DE)

(21) Appl. No.: 13/811,412

(22) PCT Filed: Jul. 21, 2011
(86) PCT No.: PCT/EP2011/062567

§ 371 Date: Jan. 22, 2013

(30) Foreign Application Priority Data
Jul. 23, 2010 (EP) 10170685.1

(51) Int. Cl. H01H 9/20

(52) U.S. Cl. CPC H01H 9/20
USPC 200/325

(57) ABSTRACT

A switch lock for an electrical switching device, e.g. a circuit breaker, motor circuit breaker, or isolating switch, which is an improved switch lock, that can be made with fewer parts and at lower cost. Furthermore, an electrical switching device can contain this switch lock. Due to an appropriate arrangement of the spring coupling points and an appropriate spring dimensioning, as well as an appropriate geometric design of the contact piece holder, this switch lock can do without separate lock and contact pressure springs, insofar as their functions are combined in one spring.

### CROSS-REFERENCE TO RELATED APPLICATIONS

This application is a U.S. national phase application under 35 U.S.C.§371 of International Application PCT/EP2011/062567, filed on Jul. 21, 2011, and claims benefit to European Patent Application No. 10170685.1, filed on Jul. 23, 2010. The international application was published in German on Jan. 26, 2012, as WO 2012/010670 A1 under PCT Article 21(2).

### FIELD

The invention relates to a switch lock for an electrical switching device, e.g. a circuit breaker, motor circuit breaker or isolating switch.

### BACKGROUND

Such a switch lock is known from DE 10 2006 059 307 B3. This switch lock consists of a contact system with at least one fixed contact and at least one movable contact piece pivoted on a contact holder, which closes the contact to the fixed contact (210) in the ON position of the switching device and isolates in the OFF position of the switching device, as well as a support lever pivoted in a bearing, and a buckle lever. Furthermore, the contact system has a knee lever, at the joint of which a lock spring applies. In the ON position, this lock spring is taut and tries to lift the contact holder and thus the flexible contact piece from the fixed contact via the lower part of the knee lever. However, as the knee lever braces itself against the support lever, the contact holder and thus the movable contact piece remain in their positions. The movable contact piece is pushed via a contact pressure spring of the contact holder into the ON position of the switching device onto the fixed contact. The switch lock has three switch positions: in the ON position, the knee lever is pushed through. On the one side, the knee lever braces itself against the support lever, on the other side, it is attached to the contact holder. In the ON position of the switching device, a handle tightens the lock spring in such a way that the spring force applied to the knee joint holds the knee joint in interaction with a knee joint stop in the pushed-through position. If the electrical switching device is switched off via the handle, the direction of action of the lock spring force is changed by the change of the position of the handle in such a way that it moves the knee lever joint towards buckling. The support lever does not move, which makes the knee lever lift the contact holder and thus the movable contact piece in such a way that the contact point of the movable contact piece loses the connection to the fixed contact and lifts off. The force of the lock spring in the OFF position of the electrical switching device prevents the movable contact piece from dropping back onto the fixed contact.

In the case of an unexpected operating state of the electrical switching device, such as a short, the buckle lever opens so that the support lever pivoted on the side does no longer find support on the opposite side pivoted on a bearing. Via the lower part of the knee lever, the lock spring now pulls the contact holder and thus the movable contact piece off of the fixed contact. This effect is amplified by the acting electrodynamic forces. The contacts are isolated from each other, even though the knee lever is still in the pushed-through position. The electrical switching device is thus neither in the ON nor the OFF position, but in the position TRIGGERED.

To switch the switching device on again, it must be put into the OFF position first. This is when the knee lever buckles. In the OFF position, the lock spring pulls the knee joint so far into the rear side opposite the stop for the pushed-through position, that a force is applied to the support lever due to the opening path of the contact holder restricted by a stop, locking it in place again with the buckle lever. The switching device is now ready to be switched on again.

The above described principle of a switch lock with knee lever is also known from a series of other documents, such as U.S. Pat. No. 3,614,685 or WO03/009324 A1. Such knee lever systems have the advantage that strong forces can be controlled with levers of relatively small dimensions. In connection with the particular kinematics of the knee lever, the low inertia associated with this leads to an advantageous quick opening in the case of triggering or switching off.

However, all described knee lever systems require numerous parts and complex constructions, which in turn cause an increase in assembly expenses and thus high costs, and do not allow for the desired compact switch lock design.

### SUMMARY

An aspect of the present invention is therefore to provide a switch lock that overcomes the above mentioned disadvantages of the state of technology while maintaining or improving switch dynamics.

An embodiment of the invention provides a switch lock for an electrical switching device including a contact system, the switch comprising: a fixed contact; a contact holder; a movable contact piece configured to pivot on the contact holder; a support lever bearing; a support lever configured to pivot on the support lever bearing; and a spring, wherein the movable contact piece is configured to close a first contact to the fixed contact in an ON position of the switching device, wherein the movable contact piece is configured to isolate the first contact from the fixed contact in an OFF position of the switching device, and wherein the spring is dimensioned and mounted in such a way that it generates a required contact force in the ON position, and accelerates a switch-off movement of the movable contact piece in a switch-off.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1: Diagram of a switch lock as per state of technology

FIG. 2: Diagram of a switch lock as per invention

FIG. 3: Diagram of a switch lock as per invention in the OFF position

FIG. 4: Diagram of a switch lock as per invention in the ON position

FIG. 5: Diagram of a switch lock as per invention in the moment of triggering

FIG. 6: Diagram of a switch lock as per invention in the TRIGGERED position

### DETAILED DESCRIPTION

An embodiment of a switch lock as designed by the inventor is characterised by the omission of a knee lever and the proposal of a construction with a pivotable contact holder braced against a support lever, in which, thanks to appropriate dimensioning and arrangement, only one spring performs the task of the lock spring and the task of the contact pressure spring from the switch locks known from the state of technology.

An embodiment of the present invention provides an electrical switching device for one or more current phases, that can be manufactured at low cost and has a compact build.

The electrical switching devices as designed by the inventor are characterised in that they contain one or more electrical switching devices as per invention with the combination of features the above switch lock.

As per invention, the movable contact piece can be attached to a contact holder so it can rotate. The spring applies to this contact holder. This spring in turn is attached to an assembly which can be moved by a handle to switch the switching device on or off. The contact holder can be fixed with a first end so it can rotate, while it braces itself, in the ON and in the OFF state of the electrical switching device, with the second end against a support lever that is fixed so it can rotate unilaterally. In the OFF position, the spring holds the movable contact piece in the open position, i.e. the movable contact piece is lifted off of the fixed contact. The spring has the function of the lock spring from the switch locks known from the state of technology.

If the handle is moved into the ON position, the coupling point of the spring with the assembly moved by the handle changes such that it now pulls the movable contact piece onto the fixed contact. The spring now acts as a contact pressure spring.

In the case of an unexpected operating state of the electrical switching device, such as a short, the support lever rotates around its pivotable coupling point, so that the unilaterally pivotable contact holder no longer finds support on the side opposite of the pivotable bearing. The spring now pulls the contact holder and thus the movable contact piece off of the fixed contact. This effect is amplified by the acting electrodynamic forces. The contact holder is shaped in such a way and the movable contact piece is fixed in a rotable manner to the contact holder in such a way that the bearing location of the pivotable contact piece falls below the action line of the spring if it is triggered. The spring thus pulls the movable contact piece further away from the fixed contact. After the ON and the OFF position, the electrical switching device thus is in a further, third switching position, the TRIGGERED position. This TRIGGERED position is characterised by the fact that the switching device cannot be immediately put into the ON position again from this position. First, the contact holder must be put back into the position in which it can brace itself against the support lever. Without a conscious action, the switching device cannot be switched on again.

For the switch lock as per invention, fewer parts are required, in particular no knee lever and only one spring is necessary which takes on the tasks of the lock spring as well as those of the contact pressure spring.

In a preferred embodiment, the spring is a spiral tension spring.

The electrical switching devices as designed by the inventor are characterised by the fact that they contain one or more electrical switching devices as per invention.

If the electrical switching device is a multiple-phase switching device, a switch lock as per invention can be provided for each phase.

The advantage of this variant lies in the short triggering time until the contacts have separated and which is caused by the low mass to be moved and by the low, easy to overcome moment of inertia of the relevant switch lock. Shorter triggering time leads to lower contact strain, which can be regarded as an additional advantage.

However, it is also possible to fix one or several movable contact pieces to a single contact holder for each phase. In this case, the triggering by a phase puts the joint contact holder into the OFF position, and all movable contact pieces lift off almost simultaneously from the relevant fixed contacts.

In this variant, the advantage lies in a further reduction of the required number of parts, which in turn leads to a further reduction of assembly expenses and a further cost reduction.

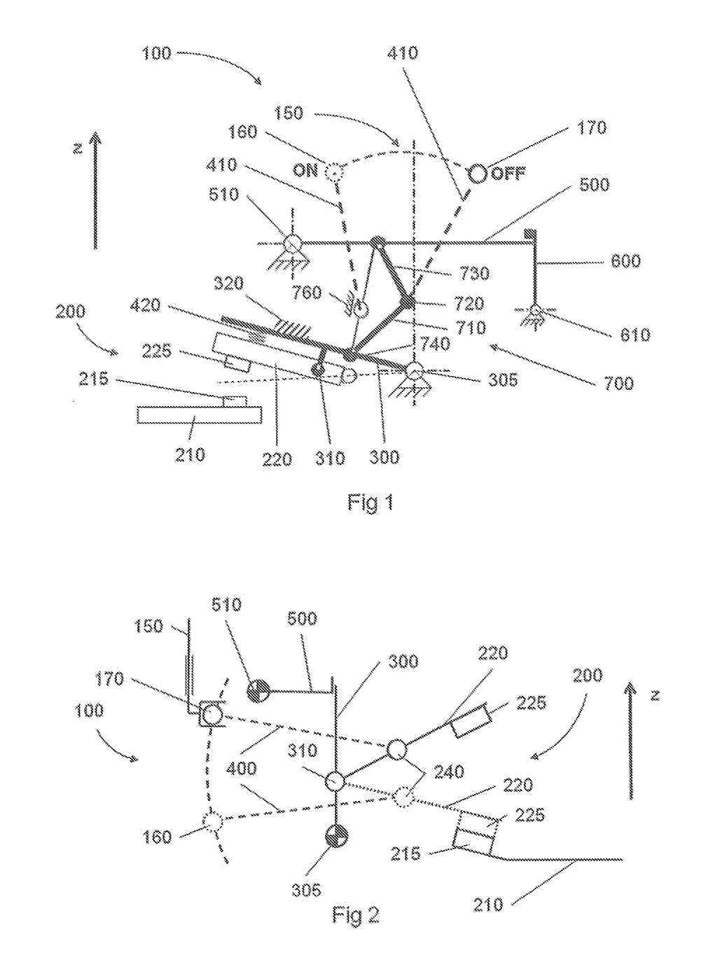

FIG. 1 shows the principle of a switch lock (100) as per state of technology. The switch lock consists of a contact system (200) with a fixed contact (210) and a movable contact piece (220), which is fixed in a rotable manner to a contact holder (300) in a contact piece bearing (310). In the ON position of the switching device, the contact between the contact plate (225) of the movable piece (220) and the contact plate (215) of the fixed contact (210) is closed, as indicated by the dotted line in FIG. 1. In the OFF position drawn by continuous lines in FIG. 1, the contact between the contact plate (225) of the movable contact piece (220) and the contact plate (215) of the fixed contact (210) is open. The contact holder (300) is fixed on one side in a rotable manner via a lower knee lever joint (740) to a knee lever system (700) consisting of a lower knee lever (710), a knee lever joint (720) and an upper knee lever (730), and on the other side via a rotable contact holder bearing to the frame of the switch lock (100). The knee lever joint (700) in turn is braced via a rotable upper knee lever joint (750) against the support lever (500). This support lever (500) is fixed with its first end in a rotable manner in a support lever bearing (510) to the frame of the switch lock (100). Due to the knee lever system (700), force is applied to the support lever (500) in direction z. In the ON as well as the OFF position, a buckle lever (600) holds with its first end the support lever at its second end. The buckle lever (600) is fixed with its second end in a buckle lever bearing (610) to the frame of the switch lock (100) in a rotable manner.

A lock spring (410) is applied to the knee lever joint (720). The lock spring (410) is coupled with its second end to a movable actuation system (150). The spring coupling point of the actuation system (150) can be moved from its ON (160) to its OFF (170) position, and vice-versa. If the spring coupling point of the actuation system is in the OFF position (170), the force of the lock spring (410) acts on the knee lever joint (720) in such a way that it is pulled into a buckled position. This opens the contacts (215, 225) or leaves them in the open position. If the spring coupling point of the actuation system is in the ON position (160), the force of the lock spring (410) acts on the knee lever joint (720) in such a way that it is pulled into a stretched position against a stop. This closes the contacts (215, 225) or leaves them in the closed position. In this closed position of the contacts (215, 225), a contact pressure spring (420) acts between the contact holder (300) and the movable contact piece (220) on the movable contact piece (220) in such a way, that the contact plate (225) of the movable contact piece (220) is pushed onto the contact plate (215) of the fixed contact.

In the case of an unexpected operating state of the electrical switching device, such as a short, the buckle lever (600) opens by pivoting on the buckle lever bearing (610) in the direction of the arrow. The support level (500) pivoting on its first end in the support lever bearing (510) thus no longer finds support at its second end and opens in direction z. Via the lower part of the knee lever (710), the lock spring (410) now pulls the contact holder (300) and thus the movable contact piece (220) with its contact plate (225) off of the fixed contact (210). This effect is amplified by the acting electrodynamic forces. The contacts (215, 225) are isolated from each other, even though the knee lever system (700) is still in the pushed-through position. The electrical switching device is thus neither in the ON nor the OFF position, but in the position TRIGGERED between the two other positions.

To switch the switching device on again, it must be put into the OFF position first. The knee lever system (700) buckles hereby. In the OFF position, the lock spring (410) pulls the knee level joint (720) so far into the rear side opposite the stop (760) for the pushed-through position, that a force is applied to the support lever (500) due to the opening path of the contact holder restricted by a stop (320), locking it in place again with the buckle lever (600). The switching device is now ready to be switched on again.

FIG. 2 shows the principle of a switch lock (100) as designed by the inventor. The switch lock (100) is drawn in continuous lines in the open OFF position, and in dotted lines in the closed ON position. In this ON position, a fixed contact (210) and a movable contact piece (220) of a contact system (200) touch each other. A spring (400) acts on the movable contact piece (220) and on a spring coupling point (160), which is movable by means of an actuation system (150). The movable contact piece (220) is connected via a contact holder bearing (305) with a contact holder (300) so it can rotate. The contact holder (300) itself is connected with a first end via a contact holder bearing (305) to the frame of the switch lock (100) so it can rotate. With its other end, the contact holder (300) braces itself against a support lever (500). In the ON position (160) of the spring coupling point, the spring (400) applies a force to the movable contact piece (220) in lock direction, i.e. in the direction towards the fixed contact (210) and against the z direction. The spring (400) in this position (160) thus acts as a contact pressure spring (420).

If the location of the spring coupling point is changed from the ON (160) into the OFF position (170), the direction of action of the spring (400) changes such that it acts a a component in the direction of the opening, i.e. direction z. The movable contact piece (220) thus lifts off from the fixed contact (210) and remains in the open OFF position.

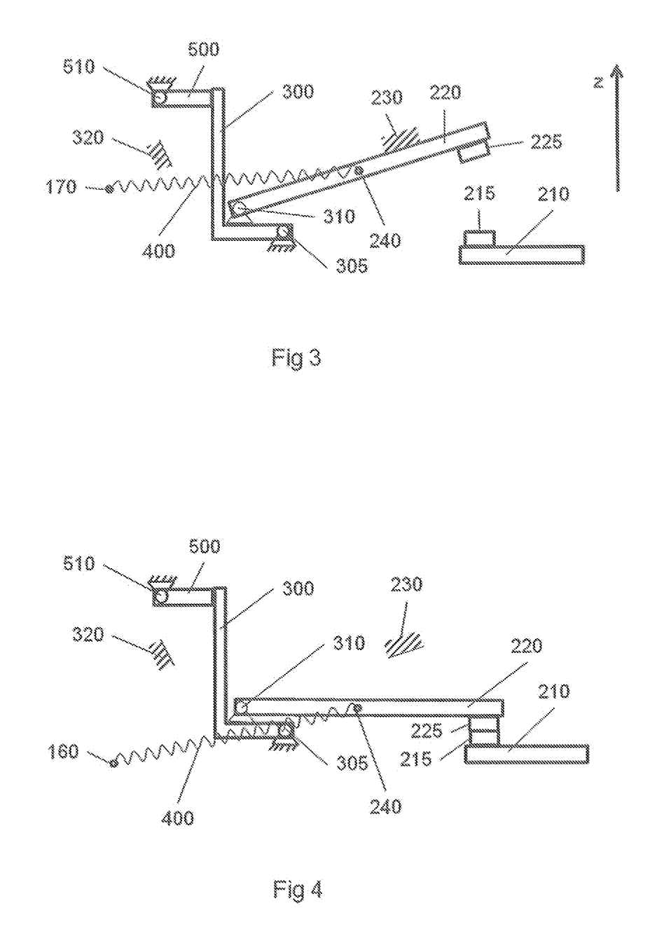

FIG. 3 shows the principle of the lock switch as per invention (100) in the OFF position in a side view. The spring coupling point (170) is in the OFF position, and the spring (400) pulls the movable contact piece (220) into the open position against a stop (230). The contact holder (300) braces itself with its upper end, as seen in direction z, against the support lever (500).

FIG. 4 shows the principle of the switch lock as per invention (100) in the ON position in a side view. The spring coupling point (160) was put into the ON position in the direction of the arrow (FIG. 3). The spring (400) now pulls the movable contact piece (220) into the closed position against the fixed contact (210).

FIG. 5 shows the principle of the switch lock as per invention (100) in the moment of triggering in a side view. The spring coupling point (160) is in the ON position. The spring (400) pulls the movable contact piece (220) into the closed position against the fixed contact (210). The support lever (500) rotates around its support lever bearing (510), as indicated by the arrow, but still supports the contact holder (300) at its upper end, as seen in direction z.

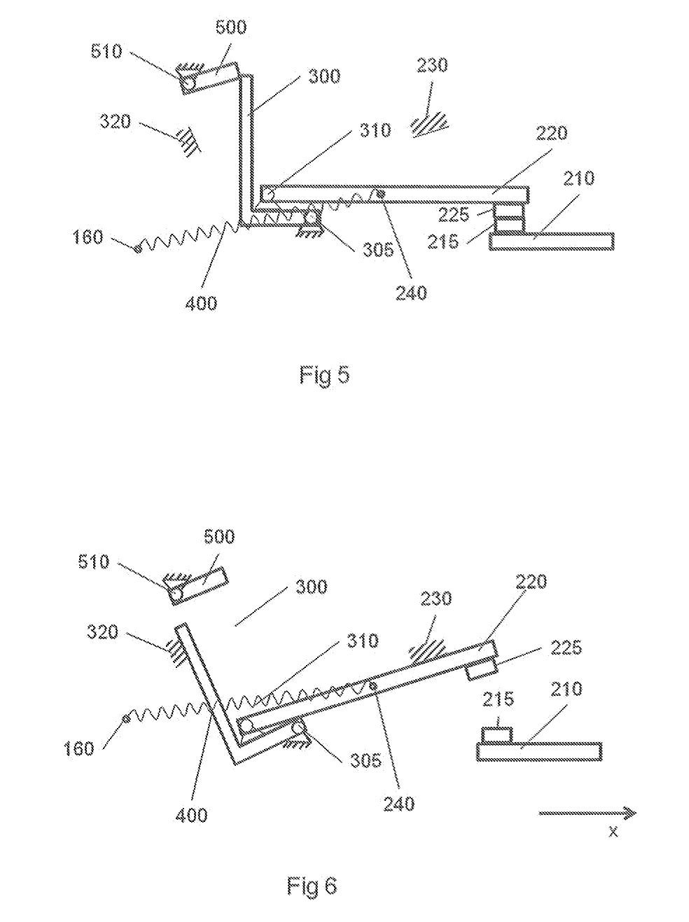

FIG. 6 shows the principle of the switch lock as per invention (100) in the TRIGGERED position in a side view. The support lever (500) has rotated so far around its support lever bearing (510), as indicated by the arrow (FIG. 5), that it no longer can support the contact holder (300). The spring (400) acts with its force in the opposite direction x, so that the contact holder (300) tips into the opposite direction x by its contact piece bearing (310). Due to the L-shape of the contact holder (300) and the arrangement of the contact piece bearing (310) on the short leg of the L, and due to the arrangement of the contact holder bearing, the movable contact piece (220) opens and loses contact with the fixed contact (210). The spring (400) reinforces this movement with its coupling points (160, 240) on the actuation system (150) and the movable contact piece (220). The acting electrodynamic forces too act in the same direction, so that the contacts (210, 220) open very quickly. The opening movements of the movable contact piece (220) and the contact holder (300) are limited by the stops (230, 320).

The invention is only described for single-phase devices. Duplicated, it can obviously be used for multiple-phase switching devices.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise.

### LIST OF REFERENCE SYMBOLS

100 Switch lock
150 Actuation system
160 Position of spring coupling point in ON position
170 Position of spring coupling point in OFF position
200 Contact system
210 Fixed contact
215 Contact plate of fixed contact
220 Movable contact piece
225 Contact plate of movable contact
230 Stop of movable contact piece
240 Coupling point of spring on movable contact piece
300 Contact holder
305 Contact holder bearing
310 Contact piece bearing
320 Contact holder stop
400 Spring
410 Lock spring
420 Contact pressure spring
500 Support lever
510 Support lever bearing
600 Buckle lever
610 Buckle lever bearing
700 Knee lever system
710 Lower knee lever
720 Knee lever joint
730 Upper knee lever
740 Lower knee lever joint
750 Upper knee lever joint
760 Stop

1. A switch lock for an electrical switching device, switch lock comprising:
a fixed contact;
a contact holder;
a movable contact piece configured to pivot on the contact holder;
a support lever bearing;
a support lever configured to pivot on the support lever bearing; and
a spring,
wherein the movable contact piece is configured make contact to the fixed contact in an ON position of the switching device and to break the contact in an OFF position of the switching device, and
wherein the spring is dimensioned and mounted in such a way that it generates a required contact force in the ON position, and accelerates a switch-off movement of the movable contact piece in a switch-off.

2. The switch lock of claim 1, wherein the spring is a spiral tension spring.

3. The switch lock of claim 1, wherein the contact holder is L-shaped, including a long leg and a short leg, and
wherein a contact piece bearing is located on the short leg of the L, between the contact holder bearing and a transition from the short to the long leg of the L.

4. An electrical switching device, comprising:
two or more phases each including a fixed contact and a movable contact piece,
wherein each phase includes respective switch lock as recited in claim 1 and
wherein the respective switch locks can trigger independently of each other.

5. An electrical switching device, comprising:
two or more phases including two or more fixed contacts and two or more movable contact pieces,
wherein the electrical switching device only has one switch lock as recited in claim 1, and
wherein all movable contact pieces are substantially simultaneously isolated from their allocated fixed contact in the switch-off.
